(19) United States
(12) Patent Application Publication
(10) Pub. No.: US 2016/0057400 A1
(43) Pub. Date: Feb. 25, 2016

(54) METHOD AND DEVICE FOR DISPLAYING OBJECTS AND OBJECT DATA OF A DESIGN PLAN

(71) Applicant: HILTI AKTIENGESELLSCHAFT, Schaan (LI)

(72) Inventors: Andreas WINTER, Feldkirch (AT); Herwig HABENBACHER, Feldkirch-Tosters (AT); Torsten GOGOLLA, Schaan (LI); Christoph WUERSCH, Werdenberg (CH)

(73) Assignee: Hilti Aktiengeselischaft, Schaan (LI)

(21) Appl. No.: 14/779,904

(22) PCT Filed: Mar. 27, 2014
(86) PCT No.: PCT/EP2014/056108

§ 371 Date: Sep. 24, 2015

(30) Foreign Application Priority Data
Mar. 28, 2013 (DE) 10 2013 205 593.5

(51) Int. Cl. H04N 9/31

(52) U.S. Cl. CPC H04N 9/3185; H04N 9/3173

(57) ABSTRACT

A method for displaying objects and object data of a design plan on a boundary surface of a room is disclosed. In a first step, a design plan of the room is selected and loaded into a control device. In a second step, the current display field of a display device is determined. In a third step, the current display field of the display device is compared on the boundary surface against the design plan, and the objects of the design plan lying in the current display field are determined. In a fourth step, projection parameters suitable for the objects lying in the current display field are determined and transmitted to the display device. In a fifth step, the objects lying in the current display field are projected by the display device on the boundary surface.

This application claims the priority of International Application No. PCT/EP2014/056108, filed Mar. 27, 2014, and German Patent Document No. 10 2013 205 593.5, filed Mar. 28, 2013, the disclosures of which are expressly incorporated by reference herein.

### BACKGROUND AND SUMMARY OF THE INVENTION

The present invention relates to a method for displaying objects and object data of a design plan on a boundary surface of a room as well as an apparatus for displaying objects and object data of a design plan.

In a construction project, many professional groups are involved with the construction planning, the construction execution, and the building inspection. In planning a construction project, an architect or construction engineer, using additional experts if applicable, generates a design plan of the construction project. The representation of objects in the design plan occurs on a scale that is adapted to the size and complexity of the construction project. In the construction process, construction planning is followed by construction work that occurs at the construction site. The construction work is carried out by construction workers and craftsmen using tools and construction equipment, and managed and coordinated by construction management or a foreman. The various craftsmen are organized in trade groups, wherein a trade group generally performs tasks that are allocated to a cohesive construction work division. Trades in the construction industry include among others: carpentry and woodworking, installation work, drywall construction, tilework, and electrical work.

In the construction work, the craftsmen must transfer, in a very time-consuming manner, the objects depicted in the design plan to the construction site, wherein transfer errors may occur. It is also disadvantageous that a conventional design plan does not show the time sequence in which the objects must be created in the construction work.

The object of the present invention consists of developing a method and an apparatus for displaying objects and object data of a design plan on a boundary surface of a room, which assist the operator and reduce errors in transferring objects from the design plan to the construction site.

According to the invention, the method for displaying objects and object data of a design plan on a boundary layer of a room is characterized in that:
In a first step, a design plan of a room is selected and loaded into a control device,
In a second step, a current display field of a projection device is determined on the boundary surface,
In a third step, the current display field is compared on the boundary surface against the design plan and the objects of the design plan lying in the current display field are determined,
In a fourth step, suitable projection parameters are determined for the objects lying in the current display field and transmitted to the projection device, and
In a fifth step, the objects lying in the current display field are projected by means of the projection device on the boundary surface.

The display of objects and object data of the design plan on the boundary surface of a room has the advantage that the objects are displayed there, where they are to be created as part of the construction work. The transfer of objects from the design plan on to boundary surfaces of the room is no longer required, so that errors in transferring objects to the substrate to be worked on no longer occur. In addition, the method according to the invention offers the ability to allocate a time sequence to the design plan objects.

In a further development, the current display field of the projection device is determined from a current position and a current orientation. To project the objects on the positions provided in the design plan on to the boundary surface, the coordinate systems of the design plan and the projection device must be coordinated with each other. The projection device is part of a display device that has at least one target object, which establishes the location coordinates of the display device in the room. The target object is suited for determining the location coordinates of the display device using a reference device.

In a first variant, the orientation of the projection device in the room is determined from the location coordinates of at least two target objects and in a second variant, the orientation of the projection device in the room is determined by means of a camera device.

In a preferred development, the second to fifth steps of the method according to the invention are repeated with a repetition frequency. The repetition of the second to fifth steps is important if the display device is moved and the position and the orientation of the display device changes. The projection device projects the objects on the boundary surface, which lie in the current display field of the projection device, This ensures that the objects that the operator wishes to see are displayed.

Particularly in regard to the execution of the method according to the invention, the apparatus for displaying objects and object data of a design plan on a boundary surface of a room comprises:
An operating device with an operating element and a control device, and
A display device with a projection device and a control device for controlling the projection device.

The apparatus according to the invention allows one to display objects of a design plan there where they are to be created as part of the construction work. The transmission of the objects from the design plan to the boundary surface of the room is eliminated so that errors in transmitting objects to the substrate to be worked on are eliminated. In addition, information about the objects and the substrate can be displayed.

To project the objects on to the positions, as provided in the design plan, on the boundary surface, the coordinate systems of the design plan and the projection device must be coordinated with each other. Coordination generally occurs with a known device for determining two or three-dimensional location coordinates, which is referred to as a reference device and may be constructed as a total station. Accordingly and in general, the design plan and the coordinate system of the reference device are initially coordinated, and then the coordinate systems of the reference device and the projection device are coordinated with each other.

Preferably, the display device has at least one target object that establishes the location coordinates of the display device in the room. The at least one target object is suited for determining the location coordinates of the display device in interior rooms using a reference device.

In a particularly preferred manner, the display device has multiple target objects that establish multiple location coordinates of the display device in the room. The target objects on the display device may be used to determine a current orientation of the display device in the room by differential generation or to increase the precision when determining the current position in the room.

Alternatively, the display device has a camera device that determines the orientation of the display device in the room. The camera device is suited, jointly with the reference device, to determine the current orientation of the display device in the room.

In a first preferred embodiment, the display device is integrated into a handheld unit with a handle. The design as a handheld unit is suited for operators who wish to obtain a quick overview of the objects to be created in a room. The operator grips the handle and directs the handheld unit with the projection device on to the boundary surface of the room on which he wishes to have the objects of the design plan displayed.

In a second preferred embodiment, the display device is integrated into an apparatus with a mounting adapter. This design allows one to mount the display device on a tripod, a height platform, etc., and is suited among other things for craftsmen performing construction work. In order to produce a drill hole using a drill in a boundary surface, for example a wall, the projection of the drill hole on the boundary surface must be constant and as precise as possible.

The apparatus is thereby designed in a particularly preferred manner to be adjustable about a rotational axis or a pivot point. The operator aligns the display device in the room in such a manner that the display device projects the objects relevant to the operator on the boundary surface. The alignment of the display device can occur manually by the operator or by means of a remote control.

In a third preferred embodiment, the display device is attached to a protective work helmet or integrated into a protective work helmet. The attachment or integration of the display device in a protective work helmet offers the advantage that the current display field of the display device always lies where the operator is looking. The objects and object data, lying in his field of view, of the design plan are displayed to the operator. If the operator initially looks at the left lateral wall of the room, then turns 180° and looks at the opposite right lateral wall, objects and object data are shown to the operator, which are arranged on the opposite right lateral wall.

Embodiments of the invention are described below using the. It does not necessarily represent the embodiments in a true-to-scale manner; instead, the drawings, where used for explanatory purposes, are drawn in a schematic and or slightly distorted manner. In regard to supplements of teachings directly visible from the drawings, one shall refer to the relevant prior art. In doing so, one shall take into account that diverse modifications and changes pertaining to the shape and detail of an embodiment may be undertaken without deviating from the general idea of the invention. The invention's features disclosed in the description, the drawings, as well as the claims may be essential individually per se as well as in any combination for further developing the invention. In addition, falling within the scope of the invention are all combinations of at least two of the features disclosed in the description, drawings and/or claims. The general idea of the invention is not restricted to the exact form or detail of the preferred embodiment shown and described in detail below or restricted to a subject matter that would be restricted in relation to the subject matter claimed in the claims. In regard to the given measurement ranges, values also lying within the cited limits shall be considered disclosed and discretionarily usable and claimable. For simplicity's sake, the same reference signs are used below for identical or similar parts or parts with identical or similar functions.

### BRIEF DESCRIPTION OF THE DRAWINGS

FIG. 1 illustrates the use of an apparatus according to the invention for displaying objects and object data of a design plan in an interior space with an operating device, a display device, and a reference device;

FIG. 2 illustrates the interaction of the operating device, display device, and reference device of the apparatus according to the invention depicted in FIG. 1 in the form of a block diagram;

FIG. 3 illustrates a method according to the invention for displaying objects and object data of a design plan on a substrate to be worked on with the apparatus according to the invention of FIG. 1;

FIGS. 4A, B illustrates the display field of the display device with a first plane (FIG. 4A) and a second plane (FIG. 4B) of the design plan using the example of the application depicted in FIG. 1; and

FIGS. 5A-C illustrates three different embodiments of the display device, which is constructed as a handheld device (FIG. 5A), integrated into a protective work helmet (FIG. 5B), and constructed as an apparatus with a mounting adapter (FIG. 5C).

### DETAILED DESCRIPTION OF THE DRAWINGS

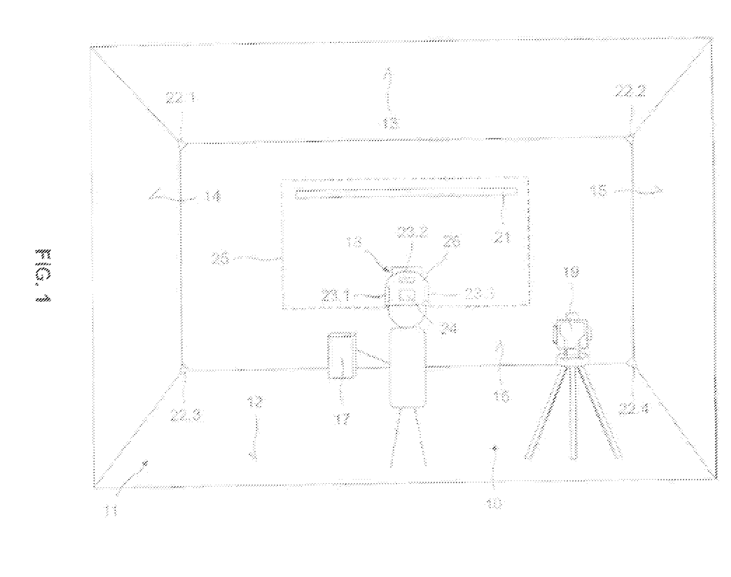

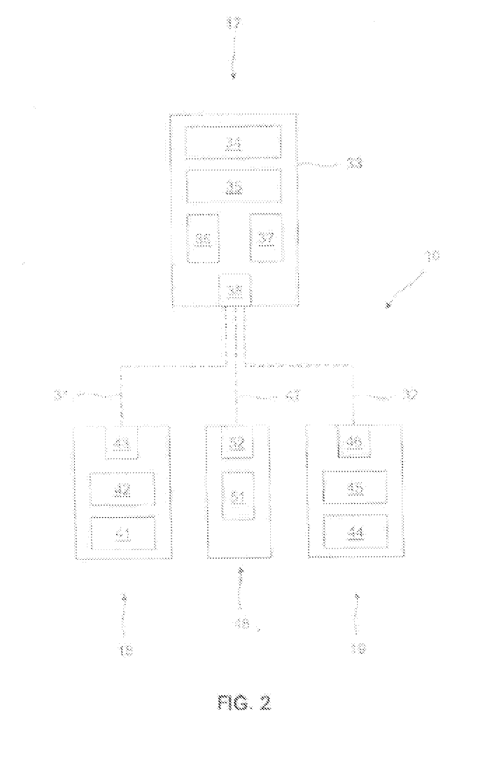

FIG. 1 depicts the use of an apparatus 10 according to the invention for displaying objects and object data of a design plan in an interior space 11. The interior space 11 consists of a floor 12, a ceiling 13, two lateral walls 14, 15, and a rear wall 16. The boundaries 12-16 of the interior space 11 are collectively summarized under the term of “boundary surfaces.”

FIG. 1 depicts the essential components of apparatus 10 in a schematic view. The apparatus 10 comprises an operating device 17, a display device 18, and a reference device 19. As an alternative to the separation of the operating device 17 and display device 18 depicted in FIG. 1, the operating device may be integrated into the display device. The apparatus 10 displays objects and object data of a design plan on a substrate. A design plan refers to a technical drawing of a construction project, in which all of the information required to produce a component or assembly is graphically depicted. The term “object” collectively refers to components, assemblies, etc. that are contained in the design plan. The object data of an object include for example the geometric dimensions of the object (length, width, or diameter).

The functioning of apparatus 10 is explained by means of a typical work task. A mounting track 21 is to be attached to the rear wall 16. The mounting track is attached by means of two mounting plates. To do so and according to a predetermined pattern, drill holes must be made into the rear wall 16, into which suitable screw anchors are subsequently inserted. The type of screw anchor and the dimensions of the screw anchor (diameter) depend on the one hand on the substrate of the rear wall 16 and on the other hand, on the load capacity of mounting track 21. The substrate of the rear wall 16 also influences the selection of a suitable drilling tool and the drilling parameters for a drill.

The apparatus 10 is intended to support various craftsmen in their tasks. Supporting tasks of the apparatus 10 include displaying the drill holes on the rear wall 16. To project the drill holes at the positions provided for in the design plan on the rear wall 16, the coordinate systems of the design plan and display device 18 are coordinated with the help of the reference device 19. In doing so, first the design plan and the coordinate system of the reference device 19 are coordinated, and then the coordinate systems of the reference device 19 and display device 18 are coordinated with each other.

Coordinating the reference device 19 with the design plan occurs with the help of known reference objects. In the design plan, multiple reference objects are defined that are located in prominent positions in interior space 11 and are therefore suited to coordinate the design plan and the coordinate system of the reference device 19. FIG. 1 shows four reference objects 22.1, 22.2, 22.3, 22.4 in the four corners of interior space 11, which border on the rear wall 16. Reflecting target objects are used as reference objects for example.

The position and orientation of the display device 18 relative to the reference device 19 is determined using target objects. The display device 18 has multiple target objects; FIG. 1 shows three target objects 23.1, 23.2, 23.3. The orientation of the display device 18 relative to the reference device 19 can be determined in an alternative manner using a camera device 24, which is attached to the display device 18. Depending on its position and orientation, the display device 18 projects a display field 25 on the boundary surface opposite the display device 18. In FIG. 1, display field 25 of display device 18 is projected on the rear wall 16. FIG. 1 depicts a display device 18 that is mounted on a protective work helmet 26.

FIG. 2 shows the interaction of the operating device 17, display device 18 and reference device 19 of the apparatus 10 according to the invention shown in FIG. 1 in the form of a block diagram.

The operating device 17 and display device 18 are constructed as separate parts and connected or connectable via a communications link 31. The operating device 17 and reference device 19 are also interconnected or interconnectable via a communication's link 32. The communication links 31, 32 may be constructed as cable-less communication links, for example as infrared, Bluetooth, WLAN, or WI-FI connections, or as cabled communication links. Besides the listed cable-less connection technologies, all already known and future cable-less connection technologies are suited for data and image transmission.

Mobile operating device 17 comprises a housing 33, into which an operating element 34 and a display element 35 are integrated. The operating element 34 and display element 35 may be constructed, as shown in FIG. 2, as separate parts or be jointly integrated into a touch screen for example. The operating device 17 also has a control device 36, a memory element 37 and a first transmitting and receiving element 38.

The display device 18 comprises a projection device 41, a control device 42 for controlling the projection device 41 and a second transmitting and receiving element 43. Based on the first transmitting and receiving element 38 of the operating device 17, the communication link 31 is set up to the second transmitting and receiving element 43 of the display device 18. The control commands for turning the projection device 41 are transmitted by the control device 36 of the operating device 17 via the communications link 31 to the control device 42 of the display device 18.

The reference device 19 comprises a laser measurement device 44, a control device 45 for controlling the laser measurement device 44, and a third transmitting and receiving element 46. The reference device 19 is constructed for example as a total station and the laser measurement device 44 is constructed as a distance and angle measurement device. Based on the first transmitting and receiving element 38 of the operating device 17, the communications link 32 is set up to the third transmitting and receiving element 46 of the reference device 19. By means of the operating element 34, the operator begins the determination of the reference position and the reference orientation. The control command for the reference determination is transmitted by the control device 36 of the operating device 17 via the communications link 32 to the control device 45 of the reference device 19.

The design plan is stored in the memory element 37 of the operating device 17. The operating device 17 may be connected via an additional communications link 47 to a central memory unit 48. The term “central memory unit” covers all electronic devices that are used for archiving data. These include a server, a notebook, a computer, an external hard drive, and a PDA. Via the communications link 47, design plans can be transmitted out of the central memory unit 48 to the operating device 17 and stored in the memory element 37, or executed design plans and associated documentation are transmitted by the operating device 17 to the central memory 48 and archived there.

The central memory 48 comprises a memory device 51 and a fourth transmitting and receiving element 52. Originating from the first transmitting and receiving element 38 of the operating device 17, the communications link 47 is set up to the fourth transmitting and receiving element 52 of the central memory 48. Data in the form of design plans, photo and video files, etc. are transmitted from the control device 36 of the operating device 17 via the communications link 47 to the memory device 51, or the control device 36 transmits data from the memory device 51 to the operating device 17.

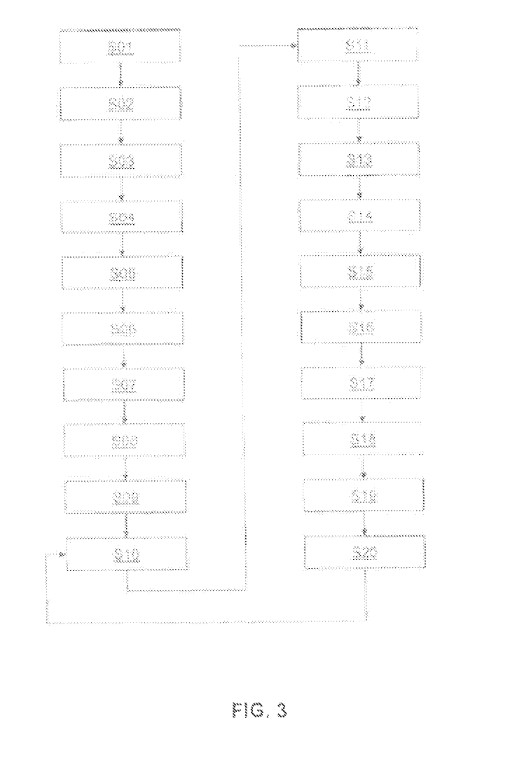

The flowchart in FIG. 3 shows a method according to the invention for displaying objects and object data of a design plan on the boundary surface 16 of the interior space 11 with the apparatus 10 according to the invention of FIG. 1.

In step S01, the operator selects on the operating device 17 a design plan of interior space 11 suited for his work task. The design plans are stored in the memory element 37 of the operating device 17 and the appropriate design plan is selected by the operator by means of the operating element 34. The design plan is loaded into the control device 36. Alternatively, the operator may set up the communications link 47 via the operating element 31 to the central memory 48 and transmit a design plan from the memory device 51 via the communications link 47 to the control device 36 of the operating device 17.

As the overall plan, the design plan may comprise all objects of the interior space 11 or as a partial plan, it may contain only a few objects. Different objects and object data in a design plan are relevant for different craftsmen, such as electricians, bricklayers, and installers. To adapt a design plan to the requirements of a respective craftsman, the sub-plans may be selected individually or in various combinations of at least two sub-plans and loaded into the control device 36 in step S01.

In step S02, the operator selects on the operating device 17 by means of the operating element 34 a first and second reference object from reference objects 22.1-22.4 contained in the design plan for the reference determination (reference positon and reference orientation). The reference determination serves to synchronize the coordinate systems of the reference device 19 and the design plan. For the reference determination, at least two reference objects are required, whose positions are indicated in the design plan. By using additional reference objects, the precision of the reference determination can be increased. In addition, the operator selects in step S03 a first and second target object from target objects 23.1-23.3. With the help of the target objects, the current position and orientation of the display device 18 relative to the reference device 19 are determined; to do so, at least two target objects are required. Alternatively, the orientation of the display device 18 relative to the reference device 19 can be determined by using the camera device 24. For determining the current positon of the display device 18, only one target object is required; by using additional target objects, the accuracy of the position determination can be increased.

In step S04, the laser measurement device 44 of the reference device 19 is oriented manually or automatically by the operator to the first reference object and the laser measurement device 44 performs in step S05 a distance and angle measurement to the first reference object. The measured distance and angle values are transmitted in step S06 via the communications link 32 to the control device 36 of the operating device 17 and stored in the control device 36. After measuring the first reference object, the second reference object is measured in a manner as the first reference object. The laser measurement device 44 is oriented in step S07 toward the second reference object and performs in step S08 a distance and angle measurement to the second reference object. The measured distance and angle values are transmitted in step S09 via the communications link 32 to the control device 36 of the operating device 17 and stored in the control device 36.

After the reference determination, the current position and orientation of the display device 18 are determined relative to the reference device 19. In step S10, the laser measurement device 44 is oriented manually or automatically by the operator to the first target object and in step S11, it performs a distance and angle measurement to the first target object. The measured distance and angle values are transmitted in a step S12 via the communications link 32 to the control device 36 of the operating device 17 and stored in the control device 36. After measuring the first target object, the second target object is measured in a similar manner as the first target object. The laser measurement device 44 is oriented in step S13 to the second target object and in step S14, it performs a distance and angle measurement to the second target object. The measured distance and angle values are transmitted in step S15 via the communications link 32 to the control device 36 of the operating device 17 and stored in the control device 36. From the measured distance and angle values for the target objects, the control device 36 calculates in step S16 the current position and the current orientation of the display device 17 relative to the reference device 19. Alternatively, the current orientation of the display device 18 relative to the reference device 19 may be determined by means of the camera device 24.

In step S17, the control device 36 determines the current display field 25 of the display device 18 from the current position and the current orientation of the display device 18. Subsequently, the control device 36 determines in step S18 appropriate projection parameters for the objects of the design plan, which are arranged in the current display field 25, and in step S19 it transmits the projection parameters to the projection device 41. The boundary surfaces 12-16 of the interior space 11 may have irregularities that impair the quality and accuracy of the projected objects. The surface of the boundary surfaces 12-16 may be determined by means of a camera; the irregularities of the boundary surfaces 12-16 may be determined by means of image processing and be taken into account in the projection parameters in step S18. The projection device 41 projects the objects and the associated object data arranged in the current display field 25 on to the rear wall 16 in step S20. After step S20, the method is continued with step S10. Steps S10 to S20 are repeated with a repetition frequency.

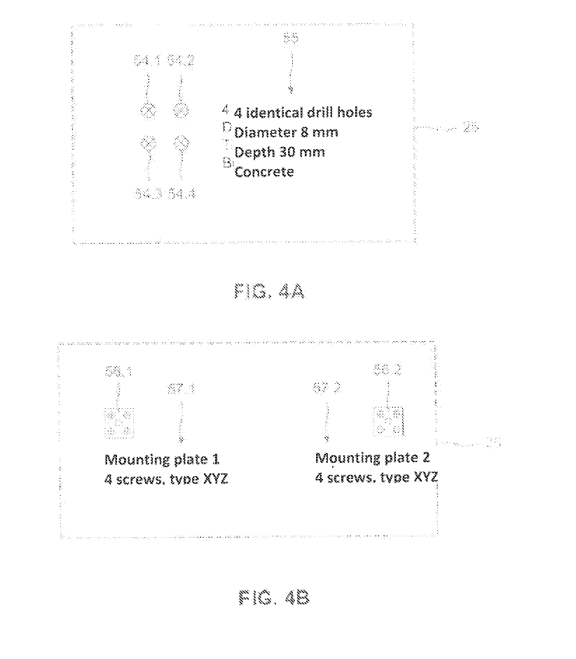

FIGS. 4A, B depict the display field 25 of the display device 18 with a first plane (FIG. 4A) and a second plane (FIG. 4B) of the design plan using the work task represented in FIG. 1 as an example. The mounting track 21 is to be attached to the rear wall 16 using two mounting plates.

FIG. 4A depicts a drill pattern with four identical drill holes 54.1-54.4, which are made in the rear wall 16. Beside the positions of the drill holes 54.1-54.4 on the rear wall 16, relevant object data 55 pertaining to the drill holes 54.1-54.4 are projected on the rear wall 16. The operator can determine the number and type of the superimposed object data 55 by means of the operating element 34. For a drill hole, the relevant object data includes for example the diameter of the drill hole (diameter 8 mm), the depth of the drill hole (depth 30 mm), and information about the substrate of the rear wall 16 (concrete).

FIG. 4B depicts a first and second mounting plate 56.1, 56.2, which are projected on the substrate. The mounting plate 10 is attached by means of the mounting plates 56.1, 56.2 to the rear wall 16. Besides the mounting plates 56.1, 56.2, the display field 25 shows the associated object data 57.1, 57.2 for the mounting plates 56.1, 56.2.

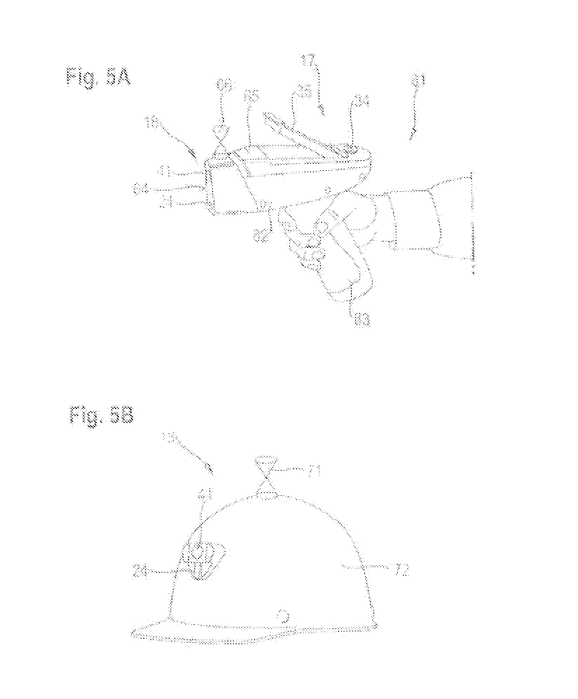

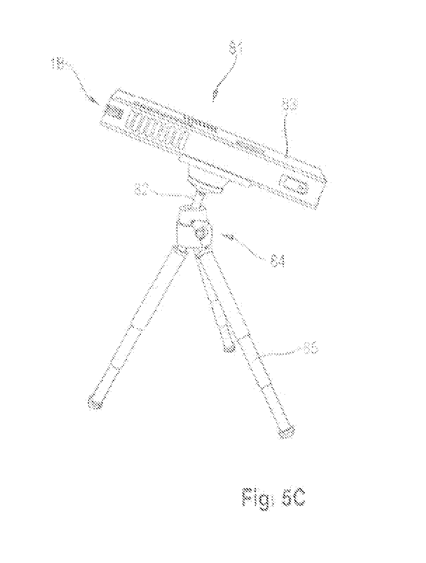

FIGS. 5A-C depict three different embodiments of display device 18, which is constructed as a handheld device (FIG. 5), integrated into a protective work helmet (FIG. 5B), and constructed as an apparatus with a mounting adapter (FIG. 5C).

FIG. 5A depicts a handheld device 61, into which the display device 18 and the operating device 17 of the apparatus 10 are integrated. The handheld device 61 comprises a device housing 62, which is connected to a handle 63. The operator clasps the handle 63 and points the handheld device 61 with a front side 64, on which the projection device 41 is arranged, to the boundary surface of the room, on which he wishes to have the objects of a design plan displayed. The operating element 34 and display element 35 of the operating device 17 are arranged on a top side 65 of the device housing 62. Located inside the device housing 62, are the control device 36 of the operating device 17 and the control device 42 for controlling the projection device 41.

The current position of the handheld device 61 or the display device 18 is determined using a target object 66, which is attached to the top side 65 of the device housing 62. The current orientation of the handheld device 61 or the display device 18 is determined using the camera device 24, which is arranged on the front side 64 of the device housing 62.

FIG. 5B depicts display device 18 of the apparatus 10 with the projection device 41, the camera device 24 and a target object 71, which are integrated into a protective work helmet 72 or attached to the protective work helmet 72. The integration of the projection device 41 into the protective work helmet 72 offers the advantage that the current display field 25 of the display device 18 always lies where the operator is looking. The operator is shown precisely the objects and object data of the design plan, which are in his field of view.

A protective work helmet is a safety helmet that is required in many industrialized countries as work safety equipment on construction sites or in other hazardous areas. On known protective work helmets, one can attach various accessory parts, such as hearing protection, a battery-operated light, or facial protection for work with power saws.

FIG. 5C depicts the display device 18 of the apparatus 10 in a third embodiment as a device 81 with a mounting adapter 82. The device 81 comprises a device housing 83 that is connected to an adjustment device 84. The device 81 is designed to be adjustable about a rotation axis or a pivot point by means of the adjustment device 84. The operator orients the display device 18 in the room in such a manner that the display field of the display device 18 projects the objects relevant to the operator on the boundary surface. The display device 18 may be oriented manually by the operator or be controlled by means of a remote control. The device 81 may be attached for example to a tripod 85 or a height platform by means of the mounting adapter 82.

1.-13. (canceled)

14. A method for displaying objects of a design plan on a boundary surface of a room, comprising the steps of:
a) selecting and loading the design plan into a control device;
b) determining a current display field of a projection device;
c) comparing the current display field of the projection device on the boundary surface against the design plan and determining the objects of the design plan lying in the current display field;
d) determining and transmitting projection parameters for the objects lying in the current display field to the projection device; and
e) projecting the objects lying in the current display field on the boundary surface by the projection device.

15. The method according to claim 14, wherein the current display field of the projection device is determined from a current position and a current orientation of the projection device in the room.

16. The method according to claim 15, wherein the current orientation of the projection device in the room is determined from position coordinates of at least two target objects.

17. The method according to claim 15, wherein the current orientation of the projection device in the room is determined by a camera device.

18. The method according to claim 14, wherein steps b) to e) are repeated at a repetition frequency.

19. An apparatus for displaying objects of a design plan on a boundary surface of a room, comprising:
an operating device with a control device, wherein the design plan is contained in the control device; and
a display device coupled to the operating device, wherein the display device has a projection device;
wherein the control device determines a current display field of the projection device;
wherein the control device compares the current display field of the projection device on the boundary surface against the design plan and determines the objects of the design plan lying in the current display field;
wherein the control device determines and transmits projection parameters for the objects lying in the current display field to the projection device;
and wherein the projection device projects the objects lying in the current display field on the boundary surface.

20. The apparatus according to claim 19, wherein the display device has at least one target object that establishes position coordinates of the display device in the room.

21. The apparatus according to claim 19, wherein the display device has a plurality of target objects that establish a plurality of position coordinates of the display device in the room.

22. The apparatus according to claim 19, wherein the display device has a camera device that determines an orientation of the display device in the room.

23. The apparatus according to claim 19, wherein the display device is integrated into a handheld device with a handle.

24. The apparatus according to claim 19, wherein the display device is integrated into a device with a mounting adapter.

25. The apparatus according to claim 24, wherein the device with the mounting adapter is adjustable about a rotation axis or a pivot point.

26. The apparatus according to claim 19, wherein the display device is mounted on a protective work helmet or is integrated into the protective work helmet.
